(19) United States
(12) Patent Application Publication
(10) Pub. No.: US 2009/0025522 A1
(43) Pub. Date: Jan. 29, 2009

(54) METHOD AND DEVICE FOR OPTIMIZING TRANSVERSE MACHINING OPERATIONS

(76) Inventors: Sven Erler, Muelsen (DE); Thomas Illig, Lohr (DE); Christian Fahrbach, Lohr (DE); Stephan Schultze, Lohr (DE)

Correspondence Address: Striker, Striker & Stenby, 103 East Neck Road, Huntington, NY, 11743, US

(21) Appl. No.: 12/173,136

(22) Filed: Jul. 15, 2008

(30) Foreign Application Priority Data
Jul. 26, 2007 (DE) 10 2007 034 834.9

(51) Int. Cl. B26D 5/08; B23C 9/00; G06F 9/44

(52) U.S. Cl. 83/523; 409/164; 717/106

(57) ABSTRACT

A method for operating a transverse machining roller of a transverse machining device, which is driven by means of a drive unit and is for the rotary machining of a product web that is transportable in a transport direction, in order to produce machined sections of product web of different formats, having the following steps:
selection of a desired format for the sections of product web,
preparation of a number of motion rules for controlling a rotary movement of the transverse machining roller in a control unit,
for the desired format, production or calculation of a movement of the transverse machining roller on the basis of motion rules prepared in the control unit and/or at least one parameter of the drive unit and/or at least one instruction of a user.

The invention relates to a method and device for optimizing transverse machining operations, a corresponding computer program, and a corresponding computer program product.

### PRIOR ART

Transverse machining applications, i.e. applications in which a material web, for example, is cut in rotary fashion by means of a transverse cutter are generally known. Other examples of transverse machining applications and corresponding transverse machining devices include transverse sealing devices, transverse perforation devices, and transverse stamping devices.

A cut-off length, which is machined, e.g. cut to length, in this context is not necessarily identical to the circumference of the transverse machining roller used. Through a suitable selection of motion rules for the transverse machining roller, it is possible for a typically material web-synchronous machining process to be carried out during the cutting and for a so-called compensation movement to be carried out the rest of the time. This compensation movement serves to achieve a shorter or longer format (cut-off length) than the so-called synchronous length, which corresponds to the circumference of the transverse machining roller.

The movement profile of the transverse machining roller therefore has a different appearance depending on the relationship between the format length and the synchronous length. With a format length that is shorter than the synchronous length, the rotation axis of the transverse machining roller must be faster during the compensation movement and in the reverse case, i.e. with a longer format length, must be slower.

To execute the compensation movement, typically a fifth degree polynomial—or a higher-degree polynomial if need be—is used in accordance with VDI Guideline 2143 “Motion Rules for Cam Mechanisms”.

In the case of format lengths that are significantly longer than the synchronous length, for example two and a half times its length, it can be suitable for the transverse machining roller to partly rotate with a negative speed, i.e. in the opposite direction from the transport direction of the material web to be transported and machined, e.g. to be cut. This is equivalent to a reverse motion.

The reverse motion in this instance continues to increase in size depending on the format and, with longer formats, would at some point become so great that the blade provided on the transverse machining roller would protrude back into the cutting zone and therefore also into the material. It goes without saying that this should be avoided.

In this context, there are known options from the prior art for preventing such reverse rotations. Typically, these eliminate any negative speed.

This assures that the rotating speeds of the transverse machining roller always assume a positive sign or at least a standstill zone, i.e. negative speeds are avoided, the maximum limit being a standstill. Depending on the desired format, due to drive-dictated limits, e.g. a maximum speed, maximum torque, or maximum acceleration of the transverse machining roller, it is possible that a maximum speed cannot be exceeded. This maximum speed depends on the motion rules used for the compensation movement. In the prior art, such a maximum speed is measured once and is then stored in the form of a fixed values table in the machine control unit or HMI (human/machine interface).

In the event of a format change, in conventional devices, the operator must adapt the machine speed to the maximum speed of the new format. In other words, the operator may have to reduce the machine speed before a so-called on-the-fly format change so as not to exceed possible limits on the drive unit in the new format. In such a case, for example, the drive unit would signal an overload malfunction and initiate a malfunction reaction, which would interrupt production. An increase in the machine speed after a format change is likewise conceivable, but must also be carried out manually by the operator in conventional devices.

Motion rules used according to in the prior art are designed to achieve the greatest possible machining performance (machine speed). No thought is given to energy considerations here.

Also in the prior art, only fixed motion rules are used for each format. At a maximum, one conversion to a motion rule without reverse motion is carried out. In addition to the consideration of whether or not a reverse motion is permissible, other motion rules are possible for optimizing the acceleration, maximum speed, and/or lost energy. No format-dictated switches are made to different types of motion rules—such as fifth degree polynomials, seventh degree polynomials, modified sinusoids, modified acceleration trapezoids, etc.

In conventional devices and methods, the drive system does not monitor the achieved precision in the machining and/or cutting region. Particularly at higher speeds and with more highly dynamic compensation movements, drag distances (deviation between actual position value and desired position value) can occur, which reduce machining precision.

A particular disadvantage in conventional devices and methods is the fact that the compensation movement is always calculated as an identical motion rule. As a result, optimizations for example with regard to maximum speed or energy consumption can only be achieved with great difficulty.

According to the prior art, a reverse rotation of a transverse machining roller is not used since it is in any case necessary to prevent a machining element, for example the cutting blade, from protruding backward into the material. Because the possibilities of a reverse rotation are not exploited, however, the drive unit is not operated in optimum fashion in terms of the achievable energy consumption and maximum speeds. The same is true for a limitation of the roller speed to a value of greater than or equal to zero.

Furthermore, in the event of a format change, in conventional devices, the new maximum speed adapted to the format to be implemented at this point cannot be calculated in an automated fashion. This results in complex test runs and the storage of fixed characteristic curves in the control unit.

On the whole, it must be concluded that with formats for which the maximum drive torque is not achieved, it is not possible to achieve an optimized energy consumption.

### Statement of Object

The object of the present invention is to overcome the above-mentioned disadvantages, i.e. in particular to permit a use of a maximum drive torque, while in particular optimizing the energy consumption.

To this end, the present invention proposes a method with the defining characteristics of claim 1.

### Advantages of the Invention

The method according to the invention makes it possible to implement an optimization of the throughput of a transverse machining device; in particular, loss-optimized curves for energy savings can be selected through a precalculated determination of achievable machine speeds. In addition, the method according to the invention makes it possible to achieve a high degree of machining precision. Through knowledge of drive limits, for example the maximum speed, maximum acceleration, or also thermal limits, it is possible to calculate in advance the maximum achievable machine speed and material web speed.

Advantageous embodiments of the method according to the invention are the subject of the dependent claims.

It is particularly preferable for the method to be used for operating a transverse cutting roller, a transverse sealing roller, a transverse perforation roller, or a transverse stamping roller of a transverse cutting device, a transverse sealing device, a transverse perforation device, or a transverse stamping device. Devices of this kind produce correspondingly cut, sealed, perforated, or stamped segments of a product web.

It is preferable for the parameters of the drive unit that go into the calculation of the permissible maximum speed of the product web to include a maximum drive unit or motor torque, a maximum drive unit or motor temperature, a maximum drive unit or motor speed, an estimation of the cutting forces occurring, and mechanical circumstances such as moments of inertia or mechanical ratios.

It is also possible, particularly in an online fashion, to monitor the machine speed by evaluating the continuous thermal output limits, such as the motor temperature or the temperature of a drive unit regulating device in order to thus optimize the cutting capacity as needed. In particular, it has not been previously possible in the prior art to precisely indicate the cutting moment, which depends on the material of the product web, as a result of which, this aspect can be optimized by means of the online monitoring and possibly learned for subsequent identical or similar productions. The expression “online monitoring” is in particular intended to mean a monitoring during the process through a comparison with calculated models.

Such an online calculation and monitoring can also be used when changing a format-dictated motion rule that is to be used or when changing a corresponding algorithm. No complex test runs over the entire format range are required. The productivity can be optimized based on the maximum executable machine speed. It is also possible to take into account a dynamic consideration of thermal models for the motor and/or for the drive unit regulating device.

According to the invention, it is in particular possible during a format change to adapt the current machine speed to a new maximum machine speed for a new format.

In the prior art, this is carried out by adapting the machine speed by means of the HMI (input by the machine operator).

If the maximum speed is known based on a calculation or preparation according to the invention (stored characteristic curve), then in the event of a format change, the control unit can suitably decrease and/or increase the machine speed in an automated fashion. In particular, it is possible here to provide a reduction in the machine speed before the format change or an increase in the machine speed after the format change.

If the maximum machine speed is limited by thermal limits, for example maximum continuous current load of the motor or drive unit regulating device, then the reduction of the machine speed can also occur after the format change, provided that the thermal behavior is taken into account. In this case, a temporary increase of the machine speed to a value greater than a permanent permissible maximum speed is permitted as long as the thermal limits are not exceeded.

This reduces the input complexity for the user in the event of a format change. This also makes it possible to optimize productivity, i.e. the maximum machine speed, through thermal optimization.

Particularly for the case in which longer formats are desired, i.e. formats that are longer than the circumference of the transverse machining roller, the maximum machine speed is no longer limited by the drive system, but rather is typically limited by the inherent process. An example of this is the maximum supply speeds of material webs. This means that the drive system can in principle implement compensation motion rules of any kind. These can now be selected according to the invention so that the lowest possible energy consumption is achieved. In this case, the energy consumption can be determined or estimated, for example, based on the square of the acceleration of the drive unit and/or the transverse machining roller. This makes it possible to minimize lost energy, thus minimizing the energy costs for the operation of a transverse cutting device according to the invention. It also turns out to be advantageous to thermally adapt the motor and drive unit regulating device or drive unit regulator to each other.

The preparation according to the invention of different format-dependent motion rules makes it possible for these regulations to also be optimized in accordance with various criteria. Examples of these criteria include the energy consumption of the compensation movement, which is particularly low, for example, if the movement of the transverse machining roller is described by means of a 3^{rd} degree polynomial.

Third degree polynomials or sinusoids, for example, have also turned out to be advantageous for optimizing the maximum speed.

It is also possible to optimize the motion rules with regard to preventing damage to the mechanical components, particularly the drive unit and/or the transverse machining roller, in particular the gears used. Modified sinusoids such as Bestehorn sinusoids with low reverse characteristic values are suitable for this. It is also possible, for example, to select the motion rules with a view to minimizing the maximum accelerations that occur. Second degree polynomials are suitable for this.

According to a particularly preferable embodiment of the method according to the invention, a format-dependent motion rule is used to calculate a compensation movement of the transverse machining roller, which in particular includes a permissible reverse rotation of the transverse machining roller in a direction opposite from the transport direction of the material web.

A reverse rotation of this kind can in particular be predetermined in the form of an angular value, with the compensation movement being limited to this value. Depending on the mechanics, this makes it possible to indicate the extent of the reverse motion. Consequently, (in the borderline case), the reverse motion can occur precisely up to the cutting region. This permits maximum stopping and acceleration distances, which leads to a significant reduction in the maximum accelerations that occur.

By means of this measure, the usable motion rules can be selected in an energy-optimized fashion, making it possible in particular to take into account heating, energy consumption, motor size, and booster size. The motion rules used can be optimized in relation to the maximum torque, e.g. the maximum speed of the advancing motion, or the size of the drive unit/motor or booster. The selected motion rule can likewise be optimized to prevent damage to the mechanical components, thus making it possible to reduce noise generation, for example.

It also turns out to be suitable to provide a monitoring of the cut precision in the cutting region of the transverse machining roller. In this connection, an online monitoring has turned out to be particularly advantageous.

One goal for a transverse machining device, e.g. a transverse cutter, is for it to travel in as linear or precise a fashion as possible in accordance with a predeterminable profile (so-called push out function or so-called cost correction) in order to execute the cut with an optimal precision. Modern drive systems offer the possibility of measuring the drag distance, i.e. the angular error between the desired position and the actual position of the transverse machining roller. The present invention now makes it possible to monitor this drag distance. If need be, it is also possible for a notification to be emitted or for the machine speed to be adapted in such a way as to assure that a predetermined limit is not exceeded.

This step makes it possible to monitor a required precision and to optimize the maximum speed by permitting a deviation. A selective optimization of correction movements is also possible. The monitoring of precision according to the invention makes it possible to produce better overall cut edges, cleaner cuts, and a higher overall quality of the cut edges of the product web.

### DESCRIPTION OF THE DRAWINGS

The invention will be described in greater detail below in conjunction with the following drawings.

FIG. 1 is a schematic depiction of the essential components of a transverse cutting device in which the invention can be advantageously used,

FIG. 2 shows cutting curves of a typical transverse machining roller application according to the prior art,

FIG. 3 shows cutting curves of a transverse cutter application according to the invention, and

FIGS. 4a, 4b, 4c show other cutting lines according to the invention that can be used for a transverse cutter.

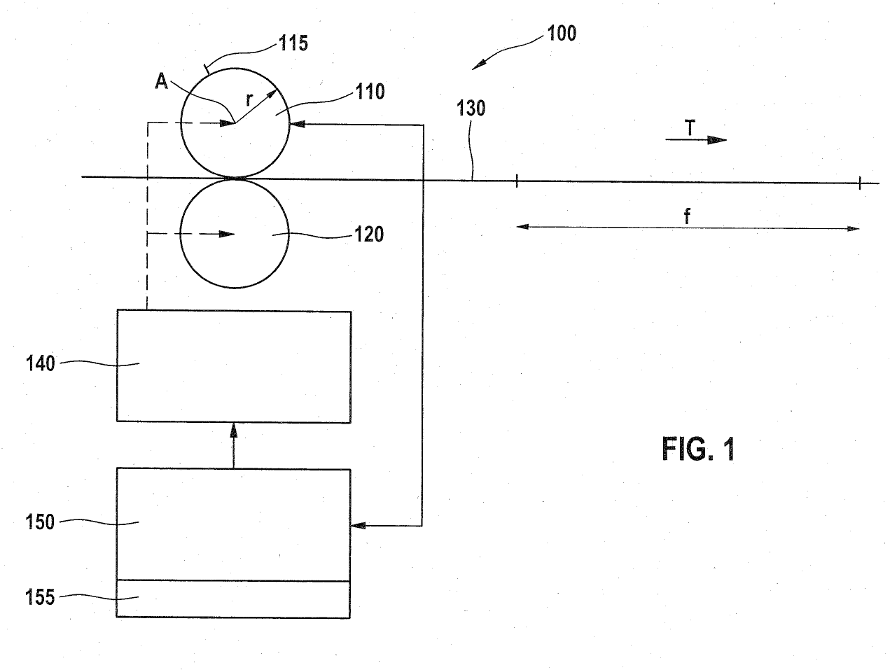

In FIG. 1, a transverse cutter device is schematically depicted and labeled as a whole with reference numeral 100. The transverse cutter device of this kind represents a preferred example of the transverse machining device according to the invention.

The transverse cutter device has a transverse machining roller 1 10 and a backing roller 120 that cooperates with it.

The transverse machining roller 110 and optionally also the backing roller 120 can be driven by means of a drive unit 140.

The drive unit is controlled by means of a control unit 150 that particularly includes an HMI 155.

Between the transverse machining roller 110 and the backing roller 120, a material web 130 is transported in the transport direction T.

A cutting device 115, which is in particular embodied in the form of cutting blade and is provided on the transverse machining roller 110, cuts the material web 130 into respective sections. If the length of the cut web sections corresponds to the circumference length of the transverse machining roller 110 (2 πr), then this is referred to as the synchronous length. The synchronous length is labeled f in FIG. 1.

Depending on the desired format length, a faster or slower movement of the transverse machining roller 110 in comparison to the transport speed of the web 130 in the transport direction T occurs, i.e. a faster or slower rotation around its rotation axis A. These courses of motion are controlled by means of the control unit 150, with corresponding control commands being issued to the drive unit 140. In particular, control commands can be entered into the control unit via the HMI 155. In addition, the input of corresponding format presets by means of the HMI enables an automatic selection or calculation of motion rules by means of the control unit 150.

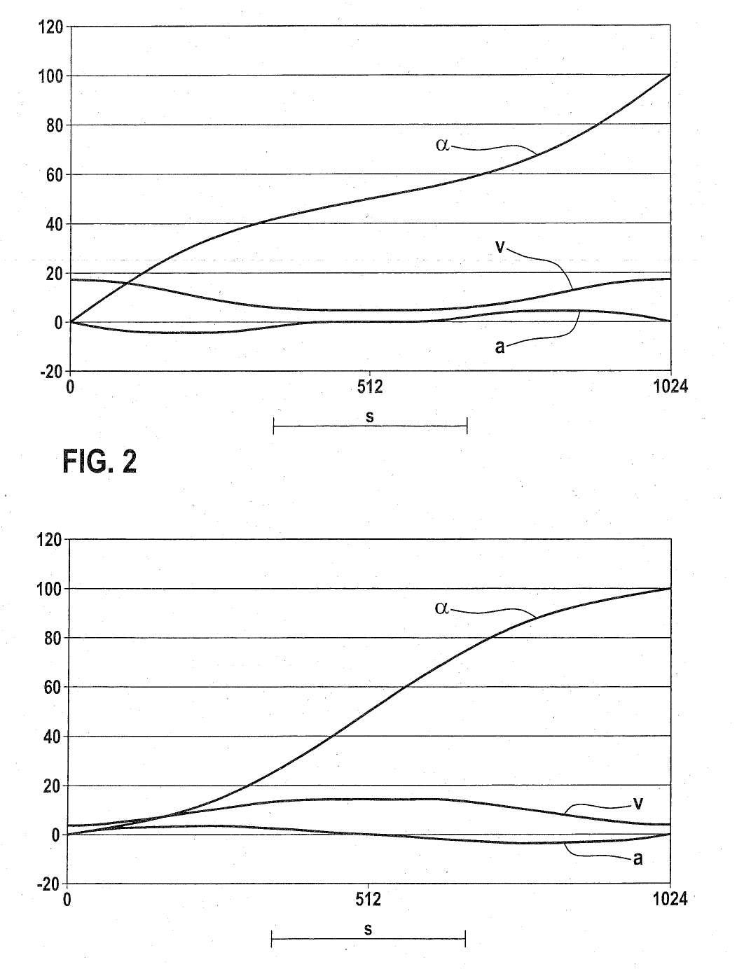

Typical courses of motion of the kind that can be executed according to the invention with a transverse cutter device as shown in FIG. 1 will now be described with reference to FIGS. 2 through 4.

In its upper portion, FIG. 2 shows cutting curves for a compensation movement of the transverse machining roller 110 in which the format length should be shorter than the synchronous length. Individual graphs are shown for the (angular) position of the roller (α), its speed (v), and its acceleration (a). In the present case, the speed v is essential. A cutting region, i.e. a region in which the cutting blade 115 cuts the material web, is labeled with the letter s. It is clear that the compensation movement is executed at a higher speed than the speed in the cutting region. In other words, as long as the cutting blade 1 15 is not situated in the cutting region, the rotation of the transverse machining roller 110 occurs at a higher speed in relation to the rotation in the cutting region. The position α and the acceleration a of the transverse machining roller result directly from the selected speed.

FIG. 2 shows the corresponding situation for a format length that should be longer than the synchronous length. It is clear that the compensation movement (outside the cutting region) is executed at a lower speed than the speed in the cutting region. But here, too, the speed always has a positive sign.

FIG. 2 essentially shows cutting curves according to the prior art.

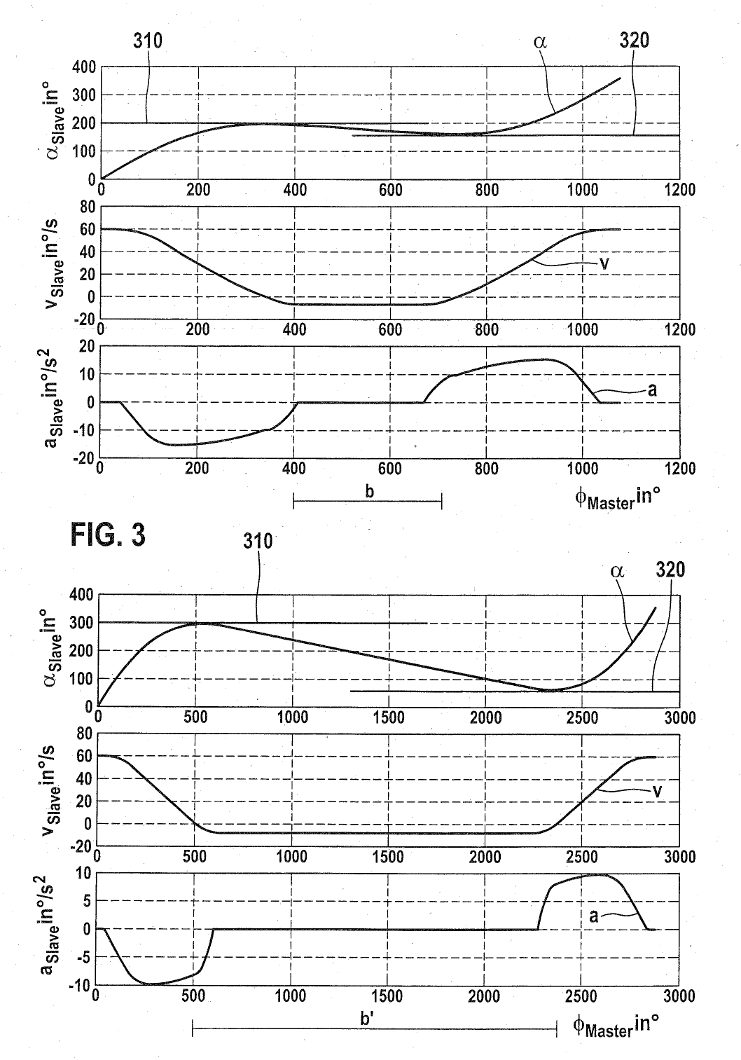

FIG. 3 shows corresponding cutting curves according to the present invention, which also permit a reverse motion.

According to the invention, the reverse motion or rotation of the transverse machining roller 110 is limited to a particular angle. In the upper portion, FIG. 3 shows two limit lines 310, 320, which demonstrate that the reverse motion of the transverse machining roller 110 here is limited to 20 degrees. The corresponding speed v of the transverse machining roller 110 is correspondingly less than zero over a certain range b.

FIG. 3 shows the corresponding situation for a compensation movement with a limitation to a reverse motion of 120°. The negative speed v is correspondingly maintained over a longer range b′.

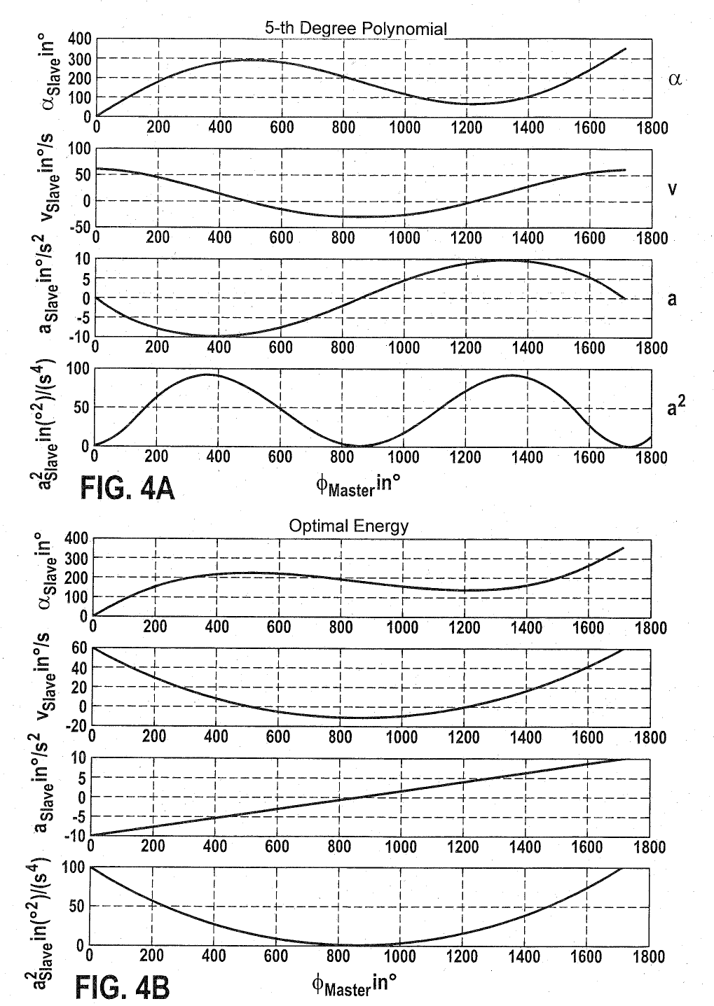

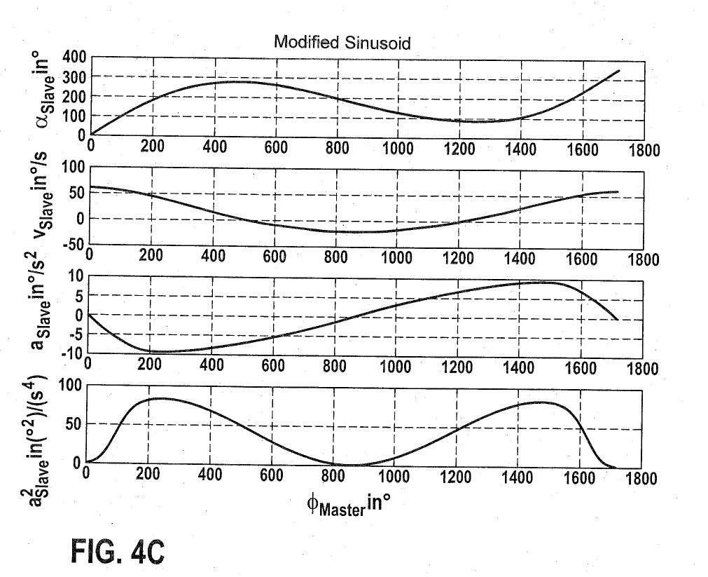

Finally, FIG. 4 shows various motion rules, which can be used in a format-dependent fashion depending on the specific guidelines.

FIG. 4a shows a compensation movement by means of a motion rule in accordance with a 5^{th} degree polynomial.

FIG. 4b shows corresponding compensation movements that are based on a 3^{rd} degree polynomial and can be used for energy optimization.

FIG. 4c shows corresponding compensation movements on the basis of a modified sinusoid.

The three respective upper graphs show the angular position α, the speed v, and the acceleration a. The respective lower graph shows the square of the acceleration a². This is the basis for a lost energy consideration.

On the basis of specific instructions from a user, for example with regard to desired format length and/or permissible reverse rotation of the transverse machining roller, the method according to the invention makes it possible to flexibly calculate, based on different motion rules, the optimal compensation movement for the respective instructions. For example, if an instruction is given that a reverse rotation should not exceed 20° or some other predeterminable angle, then the system calculates the optimum compensation movement on the basis of a multitude of possible motion rules.

### REFERENCE NUMERALS

100 transverse cutter device
110 transverse machining roller
115 cutter device
120 backing roller
130 material web
140 drive unit (motor)
150 control unit
155 HMI
A, 310, 320 limit lines
A axis of transverse machining roller
f synchronous length
r radius of transverse machining roller
T transport direction
α angular position of transverse machining roller
v speed of transverse machining roller
a acceleration of transverse machining roller
s cutting region
b, b′ ranges of negative speed

What is claimed is:

1. A method for operating a transverse machining roller of a transverse cutter device, which is driven by means of a drive unit and is for the rotary cutting of a product web that is transportable in a transport direction, in order to produce machined sections of product web in different formats, having the following steps:
selection of a desired format for the sections of product web,
preparation of a number of motion rules for controlling a rotary movement of the transverse machining roller in a control unit,
for the desired format, production or calculation of a movement of the transverse machining roller on the basis of motion rules prepared in the control unit and/or at least one parameter of the drive unit and/or at least one instruction of a user.

2. The method as recited in claim 1 for operating a transverse cutting roller, a transverse sealing roller, a transverse perforation roller, or a transverse stamping roller of a transverse cutter device, a transverse sealing device, a transverse perforation device, or a transverse stamping device.

3. The method as recited in claim 1, wherein the parameters of the drive unit include at least one element from the group including: a maximum drive unit or motor torque, a maximum drive unit or motor temperature, a maximum drive unit or motor speed, the estimated machining forces occurring, in particular cutting forces, and the mechanical circumstances such as moments of inertia or mechanical ratios.

4. The method as recited in claim 1, in which a motion rule is used to calculate a compensation movement of the transverse machining roller, which in particular includes a maximum permissible reverse rotation of the transverse machining roller in the direction opposite from the transport direction.

5. The method as recited in claim 4, in which the maximum permissible reverse rotation of the transverse machining roller is limited by means of a predeterminable angle.

6. The method as recited in claim 1, characterized by means of a monitoring of the machining precision in the machining region of the transverse machining roller.

7. A transverse machining device equipped with means for carrying out the method as recited in claim 1.

8. A computer program equipped with programming code means for carrying out all of the steps of a method as recited in claim 1 when the computer program is run on a computer or a corresponding processing unit, in particular belonging to a transverse machining device.

9. A computer program product equipped with programming code means, which are stored on a computer-readable data storage medium in order to carry out all of the steps of a method as recited in claim 1 when the computer program is run on a computer or a corresponding processing unit, in particular belonging to a transverse machining device.
